(19) United States
(12) Patent Application Publication
(10) Pub. No.: US 2025/0211738 A1
(43) Pub. Date: Jun. 26, 2025

(54) METHOD, APPARATUS, AND MEDIUM FOR VIDEO PROCESSING

(71) Applicant: Bytedance Inc., Los Angeles, CA (US)

(72) Inventors: Ye-Kui WANG, Los Angeles, CA (US); Kai ZHANG, Los Angeles, CA (US); Li ZHANG, Los Angeles, CA (US)

(21) Appl. No.: 19/074,290

(22) Filed: Mar. 7, 2025

Related U.S. Application Data
(63) Continuation of application No. PCT/US2023/073664, filed on Sep. 7, 2023.
(60) Provisional application No. 63/404,927, filed on Sep. 8, 2022.

(51) Int. Cl. H04N 19/117; H04N 19/70; H04N 19/80; H04N 19/85

(52) U.S. Cl. CPC H04N 19/117; H04N 19/70; H04N 19/80; H04N 19/85

(57) ABSTRACT

Embodiments of the present disclosure provide a solution for video processing. A method for video processing is proposed. The method comprises: performing a conversion between a current video unit of a video and a bitstream of the video, wherein the bitstream comprises a first indication being allowed to activate a target neural-network post-processing filter (NNPF), the target NNPF being applied to a plurality of video units of the video.

### CROSS-REFERENCE TO RELATED APPLICATIONS

This application is a continuation of International Application No. PCT/US2023/073664, filed on Sep. 7, 2023, which claims the benefit of U.S. Provisional Application No. 63/404,927, filed on Sep. 8, 2022. The entire contents of these applications are hereby incorporated by reference in their entireties.

### FIELDS

Embodiments of the present disclosure relates generally to video processing techniques, and more particularly, to neural-network post-filter activation.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: performing a conversion between a current video unit of a video and a bitstream of the video, wherein the bitstream comprises a first indication being allowed to activate a target neural-network post-processing filter (NNPF), the target NNPF being applied to a plurality of video units of the video.

According to the method in accordance with the first aspect of the present disclosure, a first indication in the bitstream is allowed to activate a target NNPF to be applied to a plurality of video units. Compared with the conventional solution, where an activation indication only persists for a single video unit, the proposed method can advantageously reduce the number of indications need for signaling the activation information, and thus the coding efficiency can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between a current video unit of the video and the bitstream, wherein the bitstream comprises a first indication being allowed to activate a target neural-network post-processing filter (NNPF), the target NNPF being applied to a plurality of video units of the video.

In a fifth aspect, a method for storing a bitstream of a video is proposed. The method comprises: performing a conversion between a current video unit of the video and the bitstream, wherein the bitstream comprises a first indication being allowed to activate a target neural-network post-processing filter (NNPF), the target NNPF being applied to a plurality of video units of the video; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an example illustration of luma data channels;

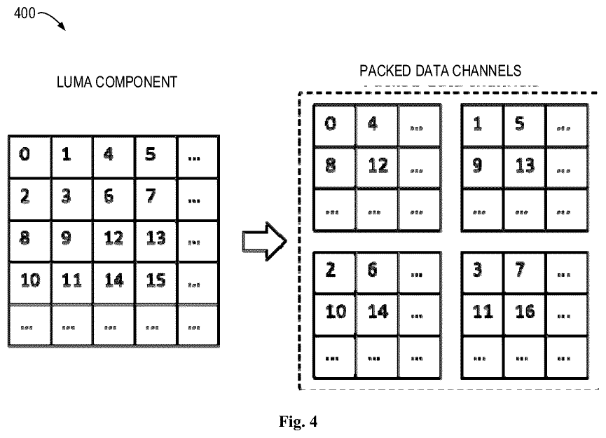

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

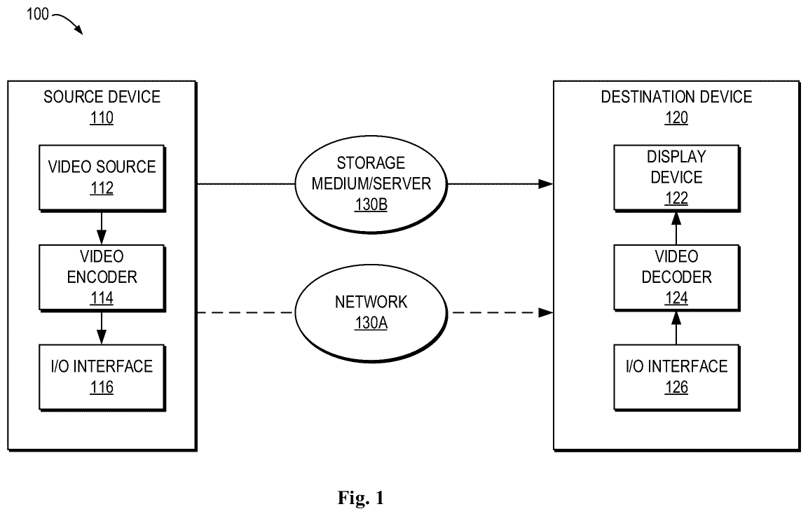

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

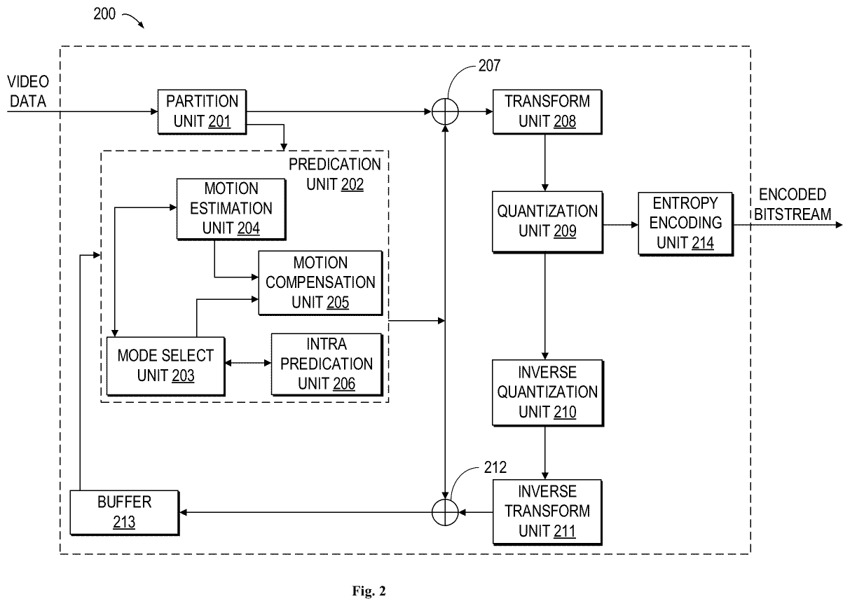

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

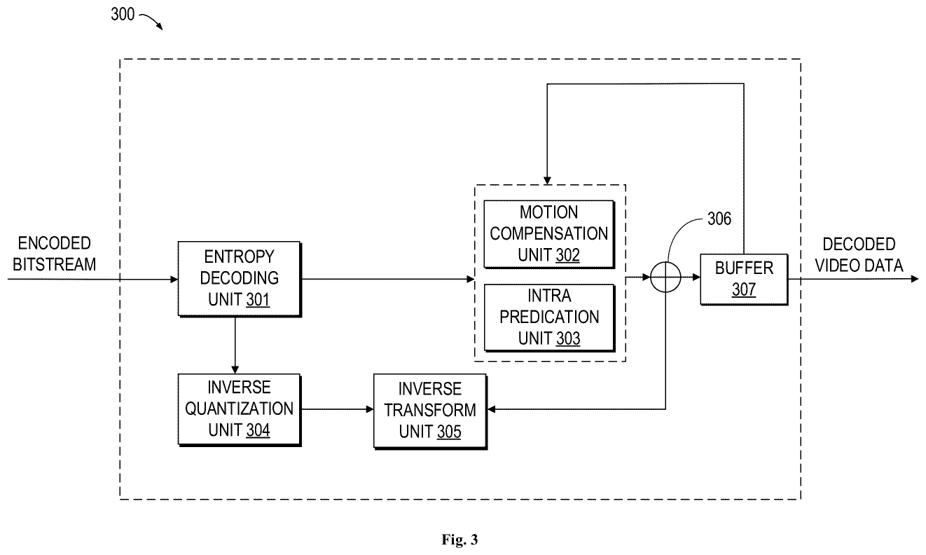

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensatio unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding technologies. Specifically, it is related to activation of a neural-network post-processing filter for use by a set of consecutive pictures or a set of pictures with same parameters (e.g., quantization parameters, temporal layer id, picture types) or samples of a set of pictures associated with the same color component. The ideas may be applied individually or in various combinations, for video bitstreams coded by any codec, e.g., the versatile video coding (VVC) standard and/or the versatile SEI messages for coded video bitstreams (VSEI) standard.

### 2. Abbreviations

APS Adaptation Parameter Set
AU Access Unit
CLVS Coded Layer Video Sequence
CLVSS Coded Layer Video Sequence Start
CRC Cyclic Redundancy Check
CVS Coded Video Sequence
FIR Finite Impulse Response
IRAP Intra Random Access Point
NAL Network Abstraction Layer
PPS Picture Parameter Set
PU Picture Unit
RASL Random Access Skipped Leading
SEI Supplemental Enhancement Information
STSA Step-wise Temporal Sublayer Access
VCL Video Coding Layer
VSEI versatile supplemental enhancement information (Rec. ITU-T H.274|ISO/IEC 23002-7)
VUI Video Usability Information
VVC versatile video coding (Rec. ITU-T H.266|ISO/IEC 23090-3)

### 3. Introduction

### 3.1. Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 3.2. SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274 | ISO/IEC 23002-7.

3.3. Signalling of neural-network post-filters

An existing design includes the specification of two SEI messages for signalling of neural-network post-filters, as follows.

### 4. Problems

The current design for the neural-network post-filter activation (NNPFA) SEI message has the following problems:

1) The NNPFA SEI message specifies the neural-network post-processing filter that may be used for post-processing filtering for the current picture. The NNPFA SEI message persists only for the current picture. However, this is inefficient when a particular filter applies to a set of consecutive pictures in either decoding order or output order.

### 5. Detailed Solutions

To solve the above problems, methods as summarized below are disclosed. The solutions should be considered as examples to explain the general concepts and should not be interpreted in a narrow way. Furthermore, these solutions can be applied individually or combined in any manner.

In the following description, the term “picture” may be replaced with any video unit, such as “slice”. The term “consecutive video units in output/decoding order” may be replaced with “a set of video units with same parameters (e.g., picture-level quantization parameters, picture types, temporal layer id) in output order”.

1) In one method, the activation of a neural-network based (NN based) operation (such as NN based post-processing filter) for a set of consecutive video units such as pictures or slices in output order is enabled, through adding an indication to the neural-network post-filter activation (NNPFA) SEI message, where this indication indicates either the activation or deactivation of the neural-network post-processing filter.
a. In one example, it is specified that nnpfa_id specifies the target neural-network post-processing filter, which is specified by one or more neural-network post-filter characteristics (NNPFC) SEI messages that pertain to the current video unit and have nnpfc_id equal to nnfpa_id.
b. In one example, it is specified that an NNPFA SEI message activates or deactivates the possible use of the target neural-network post-processing filter for post-processing filtering of a set of video units.
c. In one example, the additional indication is signalled through an additional flag named nnpfa_on_flag, and one or more of the following aspects apply:
   i. In one example, the following semantics is specified for nnpfa_on_flag equal to 1: nnpfa_on_flag equal to 1 specifies that the target neural-network post-processing filter may be used for post-processing filtering for the current video unit and all subsequent video units of the current layer in output order until one or more of the following conditions are true:
      A new CLVS of the current layer begins.
      The bitstream ends.
   A video unit in the current layer associated with a NNPFA SEI message with nnpfa_on_flag equal to 0 and the same nnpfa_id as the current SEI message is output that follows the current video unit in output order.
      NOTE—The target neural-network post-processing filter is not applied for this subsequent picture in the current layer associated with a NNPFA SEI message with nnpfa_on_flag equal to 0 and the same nnpfa_id as the current SEI message.
   ii. In one example, it is specified that nnpfa_on_flag equal to 0 specifies that the persistence of the target neural-network post-processing filter is cancelled, i.e., the target neural-network post-processing filter is no longer used unless it is activated by another NNPFA SEI message with nnpfa_on_flag equal to 1 and the same nnpfa_id as the current SEI message.

2) In one method, the activation of a NN based operation (such as post-processing filter) for a set of consecutive video units in decoding order is enabled by adding an indication to the NNPFA SEI message, with the following aspect being different from the methods specified above by item 1 and its subitems (other aspects are the same):
a. In one example, the additional indication is signalled through an additional flag named nnpfa_on_flag, and one or more of the following aspects apply:
   i. In one example, the following semantics is specified for nnpfa_on_flag equal to 1: nnpfa_on_flag equal to 1 specifies that the target neural-network post-processing filter may be used for post-processing filtering for the current video unit and all subsequent video units of the current layer in decoding order until one or more of the following conditions are true:
      A new CLVS of the current layer begins.
      The bitstream ends.
      A picture in the current layer associated with a NNPFA SEI message with nnpfa_on_flag equal to 0 and the same nnpfa_id as the current SEI message is decoded that follows the current picture in decoding order.
      NOTE—The target neural-network post-processing filter is not applied for this subsequent video unit in the current layer associated with a NNPFA SEI message with nnpfa_on_flag equal to 0 and the same nnpfa_id as the current SEI message.

3) In one method, the activation of a NN based operation (such as neural-network post-processing filter) for a set of consecutive pictures in output order is enabled by adding a new SEI message for deactivating a neural-network post-processing filter.
a. In one example, the new SEI message is named the neural-network post-filter deactivation (NNPFD) SEI message, for which the syntax only contains a ue(v)-coded syntax element nnpfd_id.
b. In one example, it is specified that nnpfd_id specifies the target neural-network post-processing filter, which is specified by one or more neural-network post-processing filter characteristics (NNPFC) SEI messages that pertain to the current picture and have nnpfc_id equal to nnfpd_id.
   i. Alternatively, instead of signalling one target neural-network post-processing filter, multiple target neural-network post-processing filters may be indicated in the NNPFD SEI message.
      1. Alternatively, furthermore, multiple instances of nnpfd_id may be signalled.
c. In one example, it is specified that an NNPFD SEI message deactivates the possible use of the target neural-network post-processing filter specified by nnpfd_id. Once the target neural-network post-processing filter is deactivated, it is no longer used unless it is activated again by a subsequent NNPFA SEI message in decoding order with nnpfa_id equal to nnpfd_id of the current SEI message.
d. In one example, it is specified that an NNPFA SEI message activates the possible use of the target neural-network post-processing filter, specified by nnpfa_id, for post-processing filtering of a set of pictures.
e. In one example, it is specified that nnpfa_id specifies the target neural-network post-processing filter, which is specified by one or more neural-network post-filter characteristics (NNPFC) SEI messages that pertain to the current picture and have nnpfc_id equal to nnfpa_id.
f. In one example, the following is specified as part of the semantics of the NNPFA SEI message:
   The target neural-network post-processing filter may be used for post-processing filtering for the current picture and all subsequent pictures of the current layer in output order until one or more of the following conditions are true:
      A new CLVS of the current layer begins.
      The bitstream ends.
      A picture in the current layer associated with a neural-network post-filter deactivation (NNPFD) SEI message with nnpfd_id equal to nnpfa_id is output that follows the current picture in output order.

NOTE—The target neural-network post-processing filter is not applied for this subsequent picture in the current layer associated with a NNPFD SEI message with nnpfd_id equal to nnpfa_id.

4) In one method, the activation of a NN based operation (such as post-processing filter) for a set of consecutive pictures in decoding order is enabled by adding a new SEI message for deactivating a NN based operation, with the following aspect being different from the methods specified above by item 3 and its subitems (other aspects are the same):
a. In one example, the following is specified as part of the semantics of the NNPFA SEI message:
   The target neural-network post-processing filter may be used for post-processing filtering for the current picture and all subsequent pictures of the current layer in decoding order until one or more of the following conditions are true:
      A new CLVS of the current layer begins.
      The bitstream ends.
      A picture in the current layer associated with a neural-network post-filter deactivation (NNPFD) SEI message with nnpfd_id equal to nnpfa_id is decoded that follows the current picture in decoding order.
      NOTE—The target neural-network post-processing filter is not applied for this subsequent picture in the current layer associated with a NNPFD SEI message with nnpfd_id equal to nnpfa_id.

5) In one method, the activation of a NN based operation (such as post-processing filter) for a set of consecutive pictures in output order is enabled by adding two indications to the NN based operation activation (NNPFA) SEI message, where one indication indicates whether to cancel the persistence of the neural-network post-processing filter, and the other indication indicates persistence of the NN based operation.
a. In one example, it is specified that nnpfa_id specifies the target neural-network post-processing filter, which is specified by one or more neural-network post-filter characteristics (NNPFC) SEI messages that pertain to the current picture and have nnpfc_id equal to nnfpa_id.
b. In one example, it is specified that an NNPFA SEI message activates or deactivates the possible use of the target neural-network post-processing filter for post-processing filtering of a set of pictures.
c. In one example, the two additional flags are named nnpfa_cancel_flag and nnpfa_persistence_flag, respectively, and nnpfa_persistence_flag is only present when nnpfa_cancel_flag is equal to 0, and one or more of the following aspects apply:
   i. In one example, it is specified that nnpfa_cancel_flag equal to 1 indicates that the persistence of the target neural-network post-processing filter established by any previous NNPFA SEI message with the same nnpfa_id as the current SEI message is cancelled, i.e., the target neural-network post-processing filter is no longer used unless it is activated by another NNPFA SEI message with the same nnpfa_id as the current SEI message and nnpfa_cancel_flag equal to 0. nnpfa_cancel_flag equal to 0 indicates that the nnpfa_persistence_flag follows.
   ii. In one example, the following semantics is specified for nnpfa_persistence_flag: nnpfa_persistence_flag specifies the persistence of the target neural-network post-processing filter for the current layer. nnpfa_persistence_flag equal to 0 specifies that the target neural-network post-processing filter may be used for post-processing filtering for the current picture only. nnpfa_persistence_flag equal to 1 specifies that the target neural-network post-processing filter may be used for post-processing filtering for the current picture and all subsequent pictures of the current layer in output order until one or more of the following conditions are true:
      A new CLVS of the current layer begins.
      The bitstream ends.
      A picture in the current layer associated with a NNPFA SEI message with the same nnpfa_id as the current SEI message and nnpfa_cancel_flag equal to 1 is output that follows the current picture in output order.
      NOTE—The target neural-network post-processing filter is not applied for this subsequent picture in the current layer associated with a NNPFA SEI message with the same nnpfa_id as the current SEI message and nnpfa_cancel_flag equal to 1.

6) In one method, the activation of a NN based operation (such as post-processing filter) for a set of consecutive pictures in decoding order is enabled by adding two indications to the NN based operation activation (NNPFA) SEI message, where one indication indicates whether to cancel the persistence of the NN based operation, and the other indication indicates persistence of the NN based operation, with the following aspect being different from the methods specified above by item 5 and its subitems (other aspects are the same):
a. In one example, the two indications are signalled through two additional flags named nnpfa_cancel_flag and nnpfa_persistence_flag, respectively, and nnpfa_persistence_flag is only present when nnpfa_cancel_flag is equal to 0, and following applies:
   i. In one example, the following semantics is specified for nnpfa_persistence_flag: nnpfa_persistence_flag specifies the persistence of the target neural-network post-processing filter for the current layer.
   nnpfa_persistence_flag equal to 0 specifies that the target neural-network post-processing filter may be used for post-processing filtering for the current picture only. nnpfa_persistence_flag equal to 1 specifies that the target neural-network post-processing filter may be used for post-processing filtering for the current picture and all subsequent pictures of the current layer in decoding order until one or more of the following conditions are true:
      A new CLVS of the current layer begins.
      The bitstream ends.
      A picture in the current layer associated with a NNPFA SEI message with the same nnpfa_id as the current SEI message and nnpfa_cancel_flag equal to 1 is decoded that follows the current picture in decoded order.
      NOTE—The target neural-network post-processing filter is not applied for this subsequent picture in the current layer associated with a NNPFA SEI message with the same nnpfa_id as the current SEI message and nnpfa_cancel_flag equal to 1.

7) In one method, how to interpret the activation message of a NN based operation (such as post-processing filter) signaled in a SEI message for a video unit (such as a picture) may depend on the coding information of the video unit.
a. For example, the SEI message may be interpreted in different ways for a I-slice (I-picture) and a P or B slice (picture).
b. For example, the SEI message may be interpreted in different ways for video units with different QPs.
c. For example, the SEI message may be interpreted in different ways for video units lossless coded or lossy coded.

8) In one method, the number of consecutive video units (e.g., pictures, or pictures with a particular set of properties) in output order to which a NN based operation (such as post-processing filter) may be applied is signalled in the NNPFA SEI message.

9) In one method, the number of consecutive video units (e.g., pictures or pictures with a particular set of properties) in decoding order to which a NN based operation (such as post-processing filter) may be applied is signalled in the NNPFA SEI message.

### 6. Embodiments

Below are some example embodiments for the case when a video unit is a picture for the solution items 1, 3, 5, and their subitems summarized above in Section 5.

Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to represent changes.

### 6.1. Embodiment 1

This embodiment is for the case when a video unit is a picture for the solution item 1 and all its subitems summarized above in Section 5.

### 6.2. Embodiment 2

This embodiment is for the case when a video unit is a picture for the solution item 3 and all its subitems summarized above in Section 5.

### 6.3. Embodiment 3

This embodiment is for the case when a video unit is a picture for the solution item 5 and all its subitems summarized above in Section 5.

More details of the embodiments of the present disclosure will be described below which are related to neural-network post-filter activation. The embodiments of the present disclosure should be considered as examples to explain the general concepts and should not be interpreted in a narrow way. Furthermore, these embodiments can be applied individually or combined in any manner.

As used herein, the term “video unit” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A video unit may be rectangular or non-rectangular. Moreover, the term “neural-network post-processing filter” and “neural-network post-filter” may be used interchangeably.

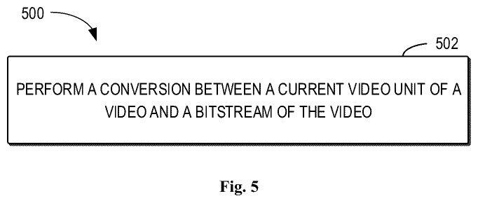

FIG. 5 illustrates a flowchart of a method 500 for video processing in accordance with some embodiments of the present disclosure. As shown in FIG. 5, at 502, a conversion between a current video unit of a video and a bitstream of the video is performed. In some embodiments, the conversion may include encoding the current video unit into the bitstream. Alternatively or additionally, the conversion may include decoding the current video unit from the bitstream.

In some embodiments, the bitstream comprises a first indication allowed to activate a target neural-network post-processing filter (NNPF). The target NNPF is applied to a plurality of video units of the video. In other words, only one first indication may be used to activate the target NNPF to be applied to the plurality of video units, and the target NNPF persists for the plurality of video units. That is, the first indication may be used to enable the application of the target NNPF to a plurality of video units, rather than only a single video unit. It should be noted that the first indication may also be used to enable the application of the target NNPF to a single video unit, if desired. By way of example rather than limitation, the first indication may be a syntax element nnpfa_persistence_flag. It should be understood that the first indication may also be a syntax element represented by any other suitable string. The scope of the present disclosure is not limited in this respect.

In view of the above, a first indication in the bitstream is allowed to activate a target NNPF to be applied to a plurality of video units. Compared with the conventional solution, where an activation indication only persists for a single video unit, the proposed method can advantageously reduce the number of indications need for signaling the activation information, and thus the coding efficiency can be improved.

In some embodiments, the plurality of video units may be in the same layer as the current video unit, i.e., the current layer. In such a case, the first indication specifies the persistence of the target NNPF for the current layer. In one example, the plurality of video units may comprise a plurality of consecutive video units in an output order. In another example, the plurality of video units may comprise a plurality of consecutive video units in a decoding order. In a further example, the plurality of video units may comprise a plurality of video units with the same parameter (e.g., picture-level quantization parameters, picture types, temporal layer id) in the output order. In a still further example, the plurality of video units may comprise samples of a set of pictures associated with the same color component. It should be understood that the above illustrations are described merely for purpose of description. The scope of the present disclosure is not limited in this respect.

In some embodiments, the bitstream may further comprise a second indication indicating an identifying number of the target NNPF. By way of example rather than limitation, the second indication may be a syntax element nnpfa_id. It should be understood that the first indication may also be a syntax element represented by any other suitable string, e.g., nnpfa_target_id. The scope of the present disclosure is not limited in this respect.

In some embodiments, the bitstream may further comprise a third indication indicating deactivation of the target NNPF. By way of example rather than limitation, the third indication may be a syntax element nnpfa_cancel_flag. It should be understood that the first indication may also be a syntax element represented by any other suitable string. The scope of the present disclosure is not limited in this respect.

In some embodiments, the first indication, the second indication and/or the third indication may be comprised in a neural-network post-filter activation (NNPFA) supplemental enhancement information (SEI) message in the bitstream.

In some embodiments, the third indication equal to a first value (e.g., 1 or the like) may indicate that persistence of the target NNPF established by a previous NNPFA SEI message with the same second indication as a current SEI message is cancelled. By way of example rather than limitation, the syntax element nnpfa_cancel_flag equal to 1 indicates that the persistence of the target NNPF established by any previous NNPFA SEI message with the same syntax element nnpfa_target_id as the current SEI message is cancelled, i.e., the target NNPF is no longer used unless it is activated by another NNPFA SEI message with the same syntax element nnpfa_target_id as the current SEI message and the syntax element nnpfa_cancel_flag equal to 0.

Additionally, the third indication equal to a second value (e.g., 0 or the like) may indicate that the first indication follows the third indication in the bitstream. By way of example rather than limitation, the syntax element nnpfa_cancel_flag equal to 0 indicates that at least the syntax element nnpfa_persistence_flag follows.

In some embodiments, the first indication equal to a third value (e.g., 0 or the like) may indicate that the target NNPF is used for post-processing filtering for the current video unit only. By way of example rather than limitation, the syntax element nnpfa_persistence_flag equal to 0 specifies that the target NNPF may be used for post-processing filtering for the current picture only.

Furthermore, the first indication equal to a fourth value (e.g., 1 or the like) may indicate that the target NNPF is used for post-processing filtering for the current video unit and all subsequent video units of a current layer associated with the current video unit in an output order until one or more of the following three conditions are met.

First Condition: a further coded layer video sequence (CLVS) of the current layer begins, the further CLVS is different from a current CLVS associated with the current video unit. For example, a new CLVS of the current layer begins to be processed.

Second Condition: the bitstream ends. For example, the processing of the bitstream of the video is completed, or the current video unit is the last video unit comprised in the bitstream.

Third Condition: a further video unit in the current layer associated with an NNPFA SEI message with the same second indication as the current SEI message is output that follows the current video unit in the output order. In some embodiments, the further video follows the current video unit in the output order and the target NNPF is not applied for the further video unit.

By way of example rather than limitation, the syntax element nnpfa_persistence_flag equal to 1 specifies that the target NNPF may be used for post-processing filtering for the current picture and all subsequent pictures of the current layer in output order until one or more of the following conditions are true: (1) a new CLVS of the current layer begins, (2) the bitstream ends, (3) a picture in the current layer associated with a NNPFA SEI message with the same syntax element nnpfa_target_id as the current SEI message is output that follows the current picture in output order. It should be noted that the target NNPF is not applied for this subsequent picture in the current layer associated with a NNPFA SEI message with the same syntax element nnpfa_target_id as the current SEI message.

In some alternative embodiments, the first indication equal to an eighth value (e.g., 1 or the like) may indicate that the target NNPF may be used for post-processing filtering for the current video unit and all subsequent video units of a current layer associated with the current video unit in a decoding order until one or more of the following conditions are met: a further coded layer video sequence (CLVS) of the current layer begins, the further CLVS is different from a current CLVS associated with the current video unit, the bitstream ends, or a further video unit in the current layer associated with an NNPFA SEI message with the same second indication as the current SEI message may be decoded that follows the current video unit in the decoding order. In some embodiments, the target NNPF is not applied for the further video unit.

By way of example rather than limitation, the syntax element nnpfa_persistence_flag equal to 1 specifies that the target neural-network post-processing filter may be used for post-processing filtering for the current picture and all subsequent pictures of the current layer in decoding order until one or more of the following conditions are true: (1) a new CLVS of the current layer begins, (2) the bitstream ends, (3) a picture in the current layer associated with a NNPFA SEI message with the same syntax element nnpfa_id as the current SEI message and the syntax element nnpfa_cancel_flag equal to 1 is decoded that follows the current picture in decoded order. It should be noted that the target neural-network post-processing filter is not applied for this subsequent picture in the current layer associated with a NNPFA SEI message with the same syntax element nnpfa_id as the current SEI message and the syntax element nnpfa_cancel_flag equal to 1.

In some embodiments, the second indication may comprise a syntax element nnpfa_id. By way of example rather than limitation, the syntax element nnpfa_id specifies the target neural-network post-processing filter, which is specified by one or more neural-network post-filter characteristics (NNPFC) SEI messages that pertain to the current picture and have nnpfc_id equal to nnfpa_id.

In some embodiments, the first indication may comprise a syntax element nnpfa_on_flag. In some embodiments, the first indication equal to a fifth value (e.g., 0 or the like) may indicate that persistence of the target NNPF is cancelled. By way of example rather than limitation, the syntax element nnpfa_on_flag equal to 0 specifies that the persistence of the target neural-network post-processing filter is cancelled, i.e., the target neural-network post-processing filter is no longer used unless it is activated by another NNPFA SEI message with the syntax element nnpfa_on_flag equal to 1 and the same syntax element nnpfa_id as the current SEI message.

In some embodiments, the first indication equal to a sixth value (e.g., 1 or the like) may indicate that the target NNPF may be used for post-processing filtering for the current video unit and all subsequent video units of a current layer associated with the current video unit in an output order until one or more of the following conditions are met: (1) a further CLVS of the current layer begins, the further CLVS is different from a current CLVS associated with the current video unit, (2) the bitstream ends, or (3) a further video unit in the current layer associated with an NNPFA SEI message with the first indication equal to the fifth value and the same second indication as a current SEI message is output that follows the current video unit in the output order. In some embodiments, the target NNPF may be not applied for the further video unit.

By way of example rather than limitation, the syntax element nnpfa_on_flag equal to 1 specifies that the target neural-network post-processing filter may be used for post-processing filtering for the current video unit and all subsequent video units of the current layer in output order until one or more of the following conditions are true: (1) a new CLVS of the current layer begins, (2) the bitstream ends, (3) a video unit in the current layer associated with a NNPFA SEI message with the syntax element nnpfa_on_flag equal to 0 and the same syntax element nnpfa_id as the current SEI message is output that follows the current video unit in output order. It should be noted that the target neural-network post-processing filter is not applied for this subsequent picture in the current layer associated with a NNPFA SEI message with the syntax element nnpfa_on_flag equal to 0 and the same syntax element nnpfa_id as the current SEI message.

In some embodiments, the first indication equal to a seventh value (e.g., 1 or the like) may indicate that the target NNPF may be used for post-processing filtering for the current video unit and all subsequent video units of a current layer associated with the current video unit in a decoding order until one or more of the following conditions are met: (1) a further CLVS of the current layer begins, the further CLVS is different from a current CLVS associated with the current video unit, (2) the bitstream ends, or (3) a further video unit in the current layer associated with an NNPFA SEI message with the first indication equal to the fifth value and the same second indication as a current SEI message may be decoded that follows the current video unit in the decoding order. In some embodiments, the target NNPF may be not applied for the further video unit.

By way of example rather than limitation, the syntax element nnpfa_on_flag equal to 1 specifies that the target neural-network post-processing filter may be used for post-processing filtering for the current video unit and all subsequent video units of the current layer in decoding order until one or more of the following conditions are true: (1) a new CLVS of the current layer begins, (2) the bitstream ends, (3) a picture in the current layer associated with a NNPFA SEI message with the syntax element nnpfa_on_flag equal to 0 and the same syntax element nnpfa_id as the current SEI message is decoded that follows the current picture in decoding order. It should be noted that the target neural-network post-processing filter is not applied for this subsequent video unit in the current layer associated with a NNPFA SEI message with the syntax element nnpfa_on_flag equal to 0 and the same syntax element nnpfa_id as the current SEI message.

In some embodiments, the first indication may comprise a first SEI message. For example, the first SEI message may be a neural-network post-filter deactivation (NNPFD) SEI message and may comprise the second indication. The second indication may be a syntax element nnpfd_id.

By way of example rather than limitation, the NNPFD SEI message may only contain a ue(v)-coded syntax element nnpfd_id, which specifies the target neural-network post-processing filter, which is specified by one or more neural-network post-processing filter characteristics (NNPFC) SEI messages that pertain to the current picture and have nnpfc_id equal to nnfpd_id.

In some embodiments, a plurality of target NNPFs may be indicated in the first SEI message. In some alternative embodiments, a plurality of instances of the second indication may be indicated in the bitstream.

By way of example rather than limitation, instead of signalling one target neural-network post-processing filter, multiple target neural-network post-processing filters may be indicated in the NNPFD SEI message. Alternatively or additionally, multiple instances of the syntax element nnpfd_id may be signalled.

In some embodiments, the first SEI message deactivates application of the target NNPF indicated by the second indication. By way of example rather than limitation, an NNPFD SEI message deactivates the possible use of the target neural-network post-processing filter specified by the syntax element nnpfd_id. Once the target neural-network post-processing filter is deactivated, it is no longer used unless it is activated again by a subsequent NNPFA SEI message in decoding order with the syntax element nnpfa_id equal to the syntax element nnpfd_id of the current SEI message.

In some embodiments, an NNPFA SEI message activates application of the target NNPF for post-processing filtering of the plurality of video units, and the target NNPF may be indicated by a first syntax element. For example, the first syntax element may be syntax element nnpfa_id.

By way of example rather than limitation, an NNPFA SEI message activates the possible use of the target neural-network post-processing filter, specified by nnpfa_id, for post-processing filtering of a set of pictures. The syntax element nnpfa_id specifies the target neural-network post-processing filter, which is specified by one or more neural-network post-filter characteristics (NNPFC) SEI messages that pertain to the current picture and have the syntax element nnpfc_id equal to the syntax element nnfpa_id.

In some embodiments, the target NNPF may be used for post-processing filtering for the current video unit and all subsequent video units of a current layer associated with the current video unit in an output order until one or more of the following conditions are met: (1) a further CLVS of the current layer begins, the further CLVS is different from a current CLVS associated with the current video unit, (2) the bitstream ends, or (3) a further video unit in the current layer associated with the first SEI message with a value of the second indication equal to a value of the first syntax element may be output that follows the current video unit in the output order. In some embodiments, the target NNPF is not applied for the further video unit.

By way of example rather than limitation, the target neural-network post-processing filter may be used for post-processing filtering for the current picture and all subsequent pictures of the current layer in output order until one or more of the following conditions are true: (1) a new CLVS of the current layer begins, (2) the bitstream ends, (3) a picture in the current layer associated with a neural-network post-filter deactivation (NNPFD) SEI message with the syntax element nnpfd_id equal to the syntax element nnpfa_id is output that follows the current picture in output order. It should be noted that the target neural-network post-processing filter is not applied for this subsequent picture in the current layer associated with a NNPFD SEI message with the syntax element nnpfd_id equal to the syntax element nnpfa_id.

In some embodiments, the target NNPF may be used for post-processing filtering for the current video unit and all subsequent video units of a current layer associated with the current video unit in a decoding order until one or more of the following conditions are met: a further CLVS of the current layer begins, the further CLVS is different from a current CLVS associated with the current video unit, the bitstream ends, or a further video unit in the current layer associated with the first SEI message with a value of the second indication equal to a value of the first syntax element may be decoded that follows the current video unit in the decoding order. In some embodiments, the target NNPF is not applied for the further video unit.

By way of example rather than limitation, the target neural-network post-processing filter may be used for post-processing filtering for the current picture and all subsequent pictures of the current layer in decoding order until one or more of the following conditions are true: (1) a new CLVS of the current layer begins, (2) the bitstream ends, (3) a picture in the current layer associated with a neural-network post-filter deactivation (NNPFD) SEI message with the syntax element nnpfd_id equal to the syntax element nnpfa_id is decoded that follows the current picture in decoding order. It should be noted that the target neural-network post-processing filter is not applied for this subsequent picture in the current layer associated with a NNPFD SEI message with the syntax element nnpfd_id equal to the syntax element nnpfa_id.

In some embodiments, information regarding how to interpret an activation message for the target NNPF may be dependent on coding information of the current video unit, and the activation message may be comprised in an SEI message for the current video unit. By way of example rather than limitation, the coding information may comprise a slice type, a picture type, a quantization parameter (QP), information regarding whether the current video unit is lossless coded, and/or the like. In one example, the SEI message may be interpreted in different ways for a I-slice (I-picture) and a P or B slice (picture). In another example, the SEI message may be interpreted in different ways for video units with different QPs. In a further example, the SEI message may be interpreted in different ways for video units lossless coded or lossy coded.

In some embodiments, the number of the plurality of video units may be indicated in the bitstream. For example, the number of consecutive video units (e.g., pictures, or pictures with a particular set of properties) in output order to which a NN based post-processing filter may be applied is signaled in the NNPFA SEI message. Alternatively, the number of consecutive video units in decoding order to which a NN based post-processing filter may be applied is signaled in the NNPFA SEI message.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a current video unit of the video and the bitstream is performed. The bitstream comprises a first indication being allowed to activate a target neural-network post-processing filter (NNPF), and the target NNPF is applied to a plurality of video units of the video.

According to still further embodiments of the present disclosure, a method for storing bitstream of a video is provided. According to the method, a conversion between a current video unit of the video and the bitstream is performed. The bitstream comprises a first indication being allowed to activate a target neural-network post-processing filter (NNPF), and the target NNPF is applied to a plurality of video units of the video. Moreover, the bitstream is stored in a non-transitory computer-readable recording medium.

The example embodiments of the present disclosure are descried above with reference to a neural-network post-processing filter. It should be understood that the concept of the present disclosure may also be applied to any other suitable neural-network based operation, such as a neural-network based down-sampling filter, a neural-network based up-sampling filter, or the like. The scope of the present disclosure is not limited in this respect.

Implementations of the present disclosure can be described in view of the following clauses, the features of which can be combined in any reasonable manner.

Clause 1. A method for video processing, comprising: performing a conversion between a current video unit of a video and a bitstream of the video, wherein the bitstream comprises a first indication being allowed to activate a target neural-network post-processing filter (NNPF), the target NNPF being applied to a plurality of video units of the video.

Clause 2. The method of clause 1, wherein the bitstream further comprises a second indication indicating an identifying number of the target NNPF.

Clause 3. The method of any of clauses 1-2, wherein the plurality of video units are in the same layer as the current video unit, and the plurality of video units comprise one of the following: a plurality of consecutive video units in an output order, a plurality of consecutive video units in a decoding order, or a plurality of video units with the same parameter in the output order.

Clause 4. The method of any of clauses 1-3, wherein a video unit is a picture or a slice.

Clause 5. The method of any of clauses 1-4, wherein the first indication is comprised in a neural-network post-filter activation (NNPFA) supplemental enhancement information (SEI) message in the bitstream.

Clause 6. The method of any of clauses 1-5, wherein the bitstream further comprises a third indication indicating deactivation of the target NNPF.

Clause 7. The method of clause 6, wherein the third indication is comprised in an NNPFA SEI message in the bitstream.

Clause 8. The method of any of clauses 6-7, wherein the first indication comprises a syntax element nnpfa_persistence_flag, or the third indication comprises a syntax element nnpfa_cancel_flag.

Clause 9. The method of any of clauses 6-8, wherein the third indication equal to a first value indicates that persistence of the target NNPF established by a previous NNPFA SEI message with the same second indication as a current SEI message is cancelled.

Clause 10. The method of clause 9, wherein the first value is 1.

Clause 11. The method of any of clauses 9-10, wherein the third indication equal to a second value indicates that the first indication follows the third indication in the bitstream.

Clause 12. The method of clause 11, wherein the second value is 0.

Clause 13. The method of any of clauses 1-12, wherein the first indication equal to a third value indicates that the target NNPF is used for post-processing filtering for the current video unit only.

Clause 14. The method of clause 13, wherein the third value is 0.

Clause 15. The method of any of clauses 13-14, wherein the first indication equal to a fourth value indicates that the target NNPF is used for post-processing filtering for the current video unit and all subsequent video units of a current layer associated with the current video unit in an output order until one or more of the following conditions are met: a further coded layer video sequence (CLVS) of the current layer begins, the further CLVS being different from a current CLVS associated with the current video unit, the bitstream ends, or a further video unit in the current layer associated with an NNPFA SEI message with the same second indication as the current SEI message is output that follows the current video unit in the output order.

Clause 16. The method of clause 15, wherein the target NNPF is not applied for the further video unit.

Clause 17. The method of any of clauses 15-16, wherein the fourth value is 1.

Clause 18. The method of any of clauses 2-17, wherein the second indication comprises a syntax element nnpfa_id.

Clause 19. The method of any of clauses 1-5 and 18, wherein the first indication comprises a syntax element nnpfa_on_flag.

Clause 20. The method of any of clauses 1-5 and 18-19, wherein the first indication equal to a fifth value indicates that persistence of the target NNPF is cancelled.

Clause 21. The method of clause 20, wherein the first indication equal to a sixth value indicates that the target NNPF is used for post-processing filtering for the current video unit and all subsequent video units of a current layer associated with the current video unit in an output order until one or more of the following conditions are met: a further CLVS of the current layer begins, the further CLVS being different from a current CLVS associated with the current video unit, the bitstream ends, or a further video unit in the current layer associated with an NNPFA SEI message with the first indication equal to the fifth value and the same second indication as a current SEI message is output that follows the current video unit in the output order.

Clause 22. The method of clause 20, wherein the first indication equal to a seventh value indicates that the target NNPF is used for post-processing filtering for the current video unit and all subsequent video units of a current layer associated with the current video unit in a decoding order until one or more of the following conditions are met: a further CLVS of the current layer begins, the further CLVS being different from a current CLVS associated with the current video unit, the bitstream ends, or a further video unit in the current layer associated with an NNPFA SEI message with the first indication equal to the fifth value and the same second indication as a current SEI message is decoded that follows the current video unit in the decoding order.

Clause 23. The method of any of clauses 21-22, wherein the target NNPF is not applied for the further video unit.

Clause 24. The method of any of clauses 1-4, wherein the first indication comprises a first SEI message.

Clause 25. The method of clause 24, wherein the first SEI message is a neural-network post-filter deactivation (NNPFD) SEI message and comprises the second indication.

Clause 26. The method of clause 25, wherein the second indication is a syntax element nnpfd_id.

Clause 27. The method of any of clauses 24-26, wherein a plurality of target NNPFs are indicated in the first SEI message.

Clause 28. The method of any of clauses 24-27, wherein a plurality of instances of the second indication is indicated in the bitstream.

Clause 29. The method of any of clauses 24-28, wherein the first SEI message deactivates application of the target NNPF indicated by the second indication.

Clause 30. The method of any of clauses 24-28, wherein an NNPFA SEI message activates application of the target NNPF for post-processing filtering of the plurality of video units, the target NNPF being indicated by a first syntax element.

Clause 31. The method of clause 30, wherein the first syntax element is syntax element nnpfa_id.

Clause 32. The method of any of clauses 30-31, wherein the target NNPF is used for post-processing filtering for the current video unit and all subsequent video units of a current layer associated with the current video unit in an output order until one or more of the following conditions are met: a further CLVS of the current layer begins, the further CLVS being different from a current CLVS associated with the current video unit, the bitstream ends, or a further video unit in the current layer associated with the first SEI message with a value of the second indication equal to a value of the first syntax element is output that follows the current video unit in the output order.

Clause 33. The method of any of clauses 30-31, wherein the target NNPF is used for post-processing filtering for the current video unit and all subsequent video units of a current layer associated with the current video unit in a decoding order until one or more of the following conditions are met: a further CLVS of the current layer begins, the further CLVS being different from a current CLVS associated with the current video unit, the bitstream ends, or a further video unit in the current layer associated with the first SEI message with a value of the second indication equal to a value of the first syntax element is decoded that follows the current video unit in the decoding order.

Clause 34. The method of any of clauses 13-14, wherein the first indication equal to an eighth value indicates that the target NNPF is used for post-processing filtering for the current video unit and all subsequent video units of a current layer associated with the current video unit in a decoding order until one or more of the following conditions are met: a further coded layer video sequence (CLVS) of the current layer begins, the further CLVS being different from a current CLVS associated with the current video unit, the bitstream ends, or a further video unit in the current layer associated with an NNPFA SEI message with the same second indication as the current SEI message is decoded that follows the current video unit in the decoding order.

Clause 35. The method of any of clauses 32-35, wherein the target NNPF is not applied for the further video unit.

Clause 36. The method of any of clauses 1-35, wherein information regarding how to interpret an activation message for the target NNPF is dependent on coding information of the current video unit, the activation message being comprised in an SEI message for the current video unit.

Clause 37. The method of clause 36, wherein the coding information comprises at least one of the following: a slice type, a picture type, a quantization parameter (QP), or information regarding whether the current video unit is lossless coded.

Clause 38. The method of any of clauses 1-38, wherein the number of the plurality of video units is indicated in the bitstream.

Clause 39. The method of any of clauses 1-38, wherein the conversion includes encoding the current video unit into the bitstream.

Clause 40. The method of any of clauses 1-38, wherein the conversion includes decoding the current video unit from the bitstream.

Clause 41. An apparatus for video processing comprising a processor and a non-transitory memory with instructions thereon, wherein the instructions upon execution by the processor, cause the processor to perform a method in accordance with any of clauses 1-40.

Clause 42. A non-transitory computer-readable storage medium storing instructions that cause a processor to perform a method in accordance with any of clauses 1-40.

Clause 43. A non-transitory computer-readable recording medium storing a bitstream of a video which is generated by a method performed by an apparatus for video processing, wherein the method comprises: performing a conversion between a current video unit of the video and the bitstream, wherein the bitstream comprises a first indication being allowed to activate a target neural-network post-processing filter (NNPF), the target NNPF being applied to a plurality of video units of the video.

Clause 44. A method for storing a bitstream of a video, comprising: performing a conversion between a current video unit of the video and the bitstream, wherein the bitstream comprises a first indication being allowed to activate a target neural-network post-processing filter (NNPF), the target NNPF being applied to a plurality of video units of the video; and storing the bitstream in a non-transitory computer-readable recording medium.

### Example Device

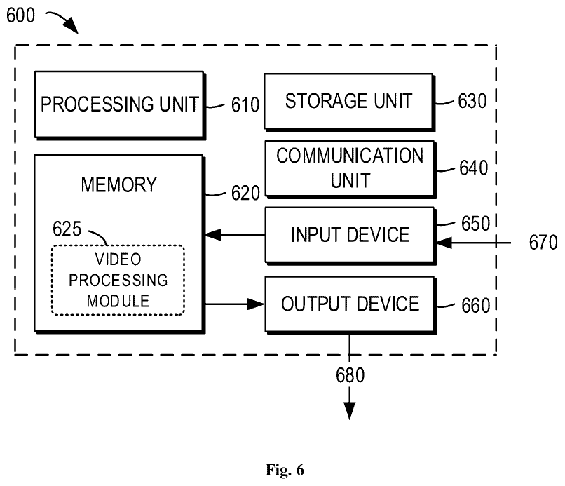

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non- volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
performing a conversion between a current video unit of a video and a bitstream of the video, wherein the bitstream comprises a first indication being allowed to activate a target neural-network post-processing filter (NNPF), the target NNPF being applied to a plurality of video units of the video.

2. The method of claim 1, wherein the bitstream further comprises a second indication indicating an identifying number of the target NNPF.

3. The method of claim 1, wherein the plurality of video units are in a same layer as the current video unit, and the plurality of video units comprise one of the following:
a plurality of consecutive video units in an output order,
a plurality of consecutive video units in a decoding order, or
a plurality of video units with a same parameter in the output order.

4. The method of claim 1, wherein a video unit is a picture or a slice.

5. The method of claim 1, wherein the first indication is comprised in a neural-network post-filter activation (NNPFA) supplemental enhancement information (SEI) message in the bitstream.

6. The method of claim 2, wherein the bitstream further comprises a third indication indicating deactivation of the target NNPF.

7. The method of claim 6, wherein the third indication is comprised in an NNPFA SEI message in the bitstream.

8. The method of claim 6, wherein the first indication comprises a syntax element nnpfa_persistence_flag, or the third indication comprises a syntax element nnpfa_cancel_flag.

9. The method of claim 6, wherein the third indication equal to a first value indicates that persistence of the target NNPF established by a previous NNPFA SEI message with a same second indication as a current SEI message is cancelled.

10. The method of claim 9, wherein the first value is 1.

11. The method of claim 9, wherein the third indication equal to a second value indicates that the first indication follows the third indication in the bitstream.

12. The method of claim 11, wherein the second value is 0.

13. The method of claim 1, wherein the first indication equal to a third value indicates that the target NNPF is used for post-processing filtering for the current video unit only.

14. The method of claim 13, wherein the third value is 0.

15. The method of claim 13, wherein the first indication equal to a fourth value indicates that the target NNPF is used for the post-processing filtering for the current video unit and all subsequent video units of a current layer associated with the current video unit in an output order until one or more of the following conditions are met:
a further coded layer video sequence (CLVS) of the current layer begins, the further CLVS being different from a current CLVS associated with the current video unit,
the bitstream ends, or
a further video unit in the current layer associated with an NNPFA SEI message with a same second indication as a current SEI message is output that follows the current video unit in the output order.

16. The method of claim 15, wherein the target NNPF is not applied for the further video unit, or wherein the fourth value is 1.

17. The method of claim 1, wherein the conversion includes encoding the current video unit into the bitstream, or
wherein the conversion includes decoding the current video unit from the bitstream.

18. An apparatus for video processing comprising a processor and a non-transitory memory with instructions thereon, wherein the instructions upon execution by the processor, cause the processor to perform acts comprising:
performing a conversion between a current video unit of a video and a bitstream of the video, wherein the bitstream comprises a first indication being allowed to activate a target neural-network post-processing filter (NNPF), the target NNPF being applied to a plurality of video units of the video.

19. A non-transitory computer-readable storage medium storing instructions that cause a processor to perform acts comprising:
performing a conversion between a current video unit of a video and a bitstream of the video, wherein the bitstream comprises a first indication being allowed to activate a target neural-network post-processing filter (NNPF), the target NNPF being applied to a plurality of video units of the video.

20. A non-transitory computer-readable recording medium storing a bitstream of a video which is generated by a method performed by an apparatus for video processing, wherein the method comprises:
performing a conversion between a current video unit of the video and the bitstream, wherein the bitstream comprises a first indication being allowed to activate a target neural-network post-processing filter (NNPF), the target NNPF being applied to a plurality of video units of the video.
